(19) United States
(12) Patent Application Publication
(10) Pub. No.: US 2013/0247396 A1
(43) Pub. Date: Sep. 26, 2013

(54) STRUCTURE MARKING TOOL

(71) Applicant: Abraham Gevorgian, La Canada-Flintridge, CA (US)

(72) Inventor: Abraham Gevorgian, La Canada-Flintridge, CA (US)

(21) Appl. No.: 13/428,361

(22) Filed: Mar. 23, 2012

(51) Int. Cl. B43L 13/24

(52) U.S. Cl. 33/19.2

(57) ABSTRACT

A marking device is provided suitable for marking visible marks at equidistant points along a surface, where the device comprises a replaceable marker configured to durably apply a mark upon the surface from a fixed position, and further comprises a rotatable housing having an enclosed interior space, a removable face for securably and alternatively enclosing and exposing the interior space as desired, and an opening through which the marker may extend to contact the surface.

### BACKGROUND

The embodiments herein relate generally to a device for marking the location of components in a structure, and more specifically to embodiments of a stud marker for easily laying out where studs should be placed in a wall.

For years, those tasked with building structures that include vertical components have relied upon inefficient techniques to mark where such components should be placed. In the context of a wall with studs, marks are typically placed on a floor or base plate identifying where the studs should be placed, often at 16″ centers. The carpenter often uses a tape rule to mark the locations, which can be a bit cumbersome and time consuming. Efforts have been made over the years to develop devices to eliminate or at least reduce the need to use a tape measure, but those devices have not proven to be as practical as had been hoped. Thus, the remains a desire to improve upon the traditional techniques for marking the location of vertical components in a structure.

### SUMMARY

A marking device is provided suitable for automatically marking locations at equidistant points along a surface. In embodiments of the present invention, the device comprises a replaceable marker configured to durably apply a mark upon the surface from a fixed position, with the marker comprising a applicator for applying the mark. The device also comprises a rotatable housing having an enclosed interior space, with the rotatable housing having a removable face for securably and alternatively enclosing and exposing the interior space as desired. The rotatable housing further comprises an opening through which the marker applicator may extend to contact the surface, wherein the housing comprises a marker support configured to permit secure but releasable retention of the marker within the interior space of the housing. With such a configuration, embodiments of the present invention are configured such that the device may be moved along the surface so that marks are applied to the surface at equidistant points.

In alternative embodiments, a marking device may also comprise a guide plate affixed to the housing to assist in guiding the motion of the device along the surface. Also, the marker support within the interior of the housing may comprise a spring mount to retain the marker in a fixed position while applying sufficient pressure to the marker applicator to reliably apply marks to the surface. Moreover, a marking device may comprise a handle securable to the housing.

### BRIEF DESCRIPTION OF THE FIGURES

The detailed description of some embodiments of the invention will be is made below with reference to the accompanying figures.

FIG. 1 shows a schematic perspective view of a first embodiment of the present invention structure marking tool;

FIGS. 2A and 2B show front and side views of the embodiment of FIG. 1;

FIGS. 3A-3C show multiple views of the interior of the embodiment of FIG. 1;

FIGS. 4A and 4B shows one embodiment of marker and its employment within the interior of the embodiment of FIG. 1;

FIGS. 5A and 5B shows another embodiment of marker and its employment within the interior of another embodiment of the invention herein.

### DETAILED DESCRIPTION OF CERTAIN EMBODIMENTS

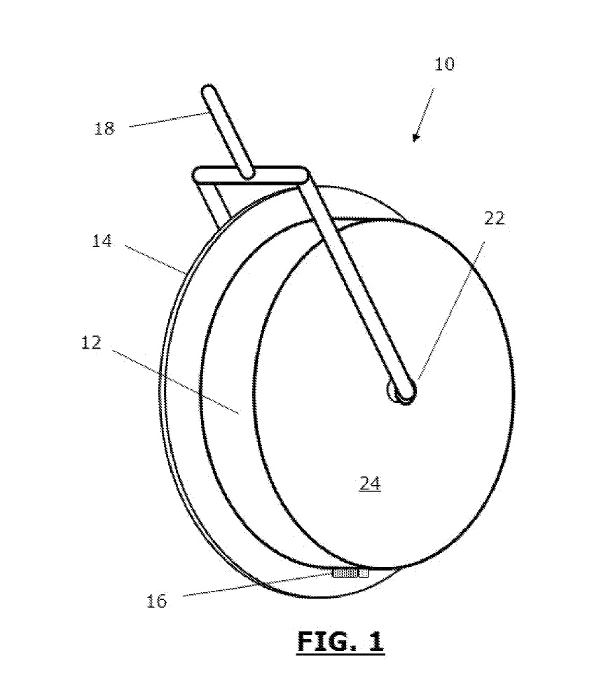

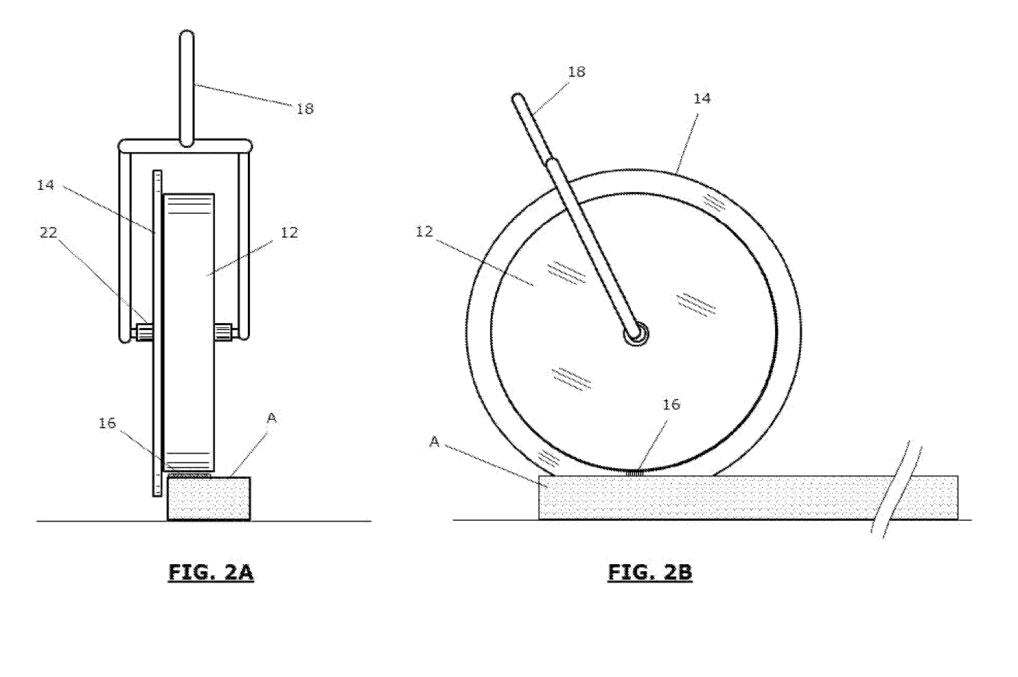

By way of example, and referring to FIGS. 1 and 2A-2B, one embodiment of the present invention comprises a structure marking tool 10 for placing indicator marks at select points on a surface A. In this example, structure marking tool 10 comprises a housing 12 and an optional guide plate 14, both having generally circular profiles that permit the structure marking tool 10 to move along a curvilinear path on surface A. Surface A may be a floor board or it may be a floor surface, or any other surface upon which it is desired to apply visible marks at uniform intervals. Geometric circularity of the housing 12 is not critical, however, as long as the structure marking tool embodiment comprises a profile that permits curvilinear movement of the structure marking tool 10 along a surface pathway.

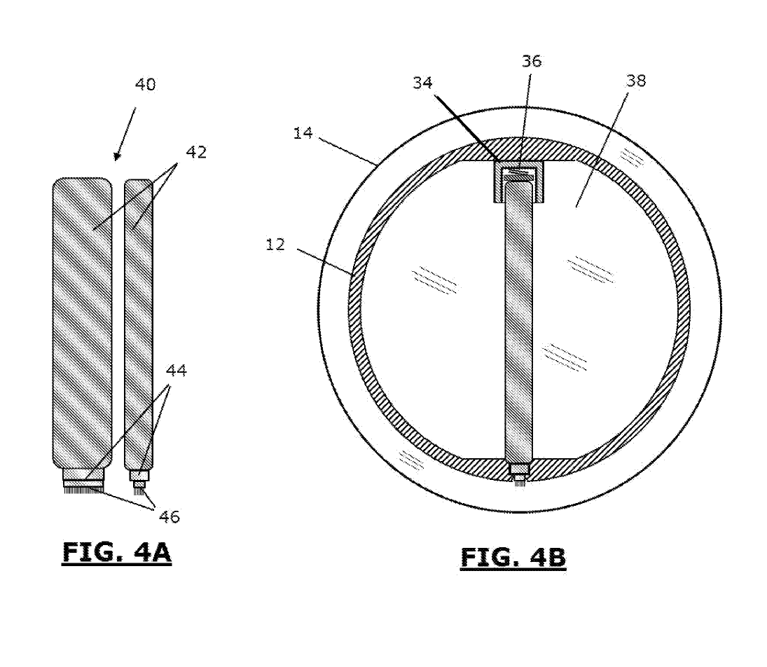

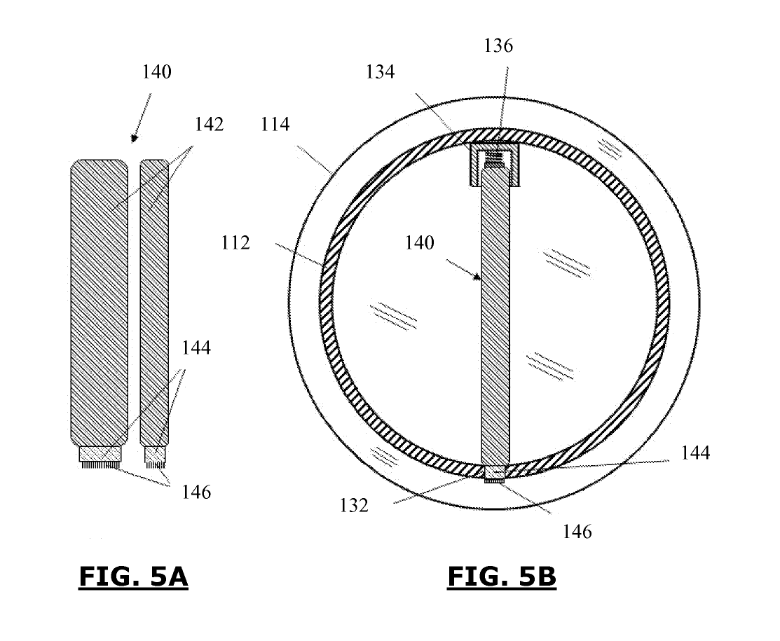

Protruding from the housing 12 is a means 16 for applying a visible mark on surface A, also described in association with FIGS. 4A and 5A. In one embodiment, marking means 16 may comprise a brush or porous tip that is configured to deliver some amount of marking medium, such as ink, chalk, paint, etc. Other synthetic or natural materials and configurations for the marking means 16 are contemplated. What is preferred is that it be sufficiently durable and reliable to apply a visible mark on surface A at intervals equal to the circumference of the housing profile. For example, it is often desired to space studs within a wall at 16″ centers. For an embodiment of the invention comprising a geometric circular housing profile, the circumference would be 2πr or πd, which for 16″ intervals would require a diameter just over 5″. A different profile would likely have a different circumference. In either case, a curvilinear path may be traced by moving the housing so that it rolls in contact with surface A. The configuration is such that the path may be purely linear, or purely curved, if so desired. By using the term curvilinear, it should be understood that a user may use embodiments of the present invention to trace any desired pathway along a surface, even one in which hard turns are desired.

If desired, the structure marking tool embodiment 10 of FIGS. 1 and 2A-2B may optionally include a handle 18 comprising one of any number of possible useful configurations that permit a user to grasp the device and move it along a curvilinear path along surface A. In one example, the handle 18 may be secured to pivot supports 22 at a central axis in the housing. One pivot support is preferably positioned at a central location on a removable face plate 24 of housing 12, with the other pivot support (not shown) on either the back face of the housing (where no guide plate exists) or the exposed face of the guide plate 14. The guide plate 14 if utilized facilitates a controlled movement of the structure marking tool 10 along the pathway. However, a steady hand of the user on either the handle or the housing may suffice to ensure controlled movement along the pathway.

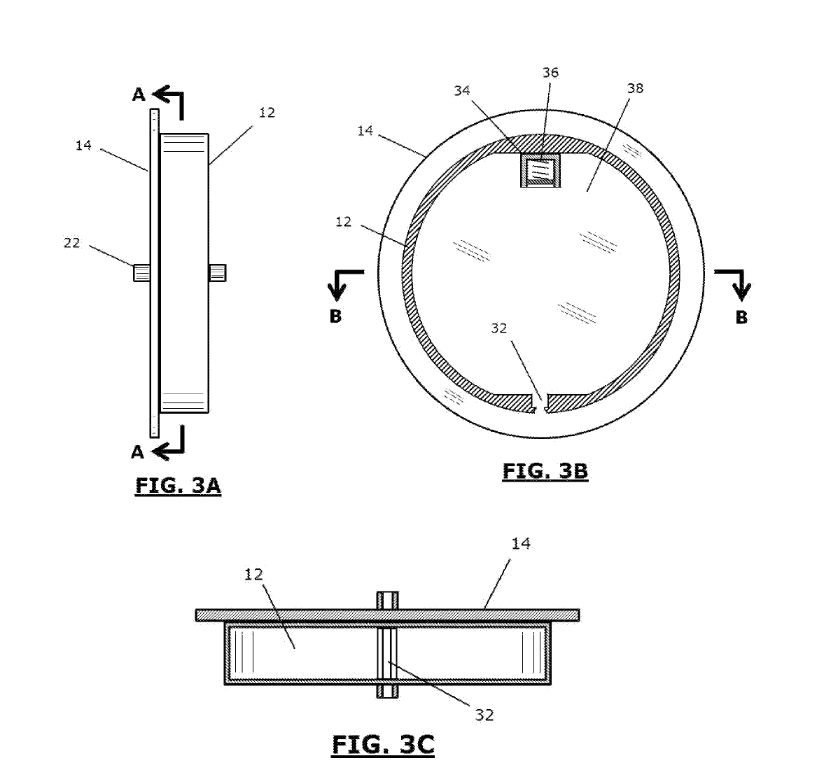

Referring now to FIGS. 3A-3C, the interior of the housing 12 may be described. In one embodiment, for example, the interior of housing 12 is hollow with means for supporting a replaceable marker (shown for example in FIGS. 4A and 5A) in a sturdy position. The housing 12 may comprise an opening 32 through which a portion of the marker may extend for applying a visible mark to surface A. The housing is preferably configured to releaseably secure the marker within a support 34 having a spring assembly 36 to exert a force upon the marker within interior 38 of housing 12 against marker opening 32. The support 34 may be one of several possible configurations designed to contain one end of the marker within housing interior 38. Likewise, the spring assembly 36 may be one of several possible configurations to secure the marker in a sturdy manner, but permit easy release where it is desired to replace the marker. It is contemplated that the interior 38 of housing 12 may be exposed by removing face plate 24 of the housing. The face plate 24 may be mechanically or magnetically connected to the housing in a secure but removable fashion to protect the interior of the housing.

The configuration of marker opening 32 is preferably contoured to the profile of the marker supporting the marking means, although it need not be. Matching contours naturally permit cleaner engagement between marker and housing, but it is not critical. What is desired is a configuration that maintains the marker in a steady and secure manner while permitting visible marks to appear on the surface A as the structure marking tool 10 is advanced along the path.

Referring to FIGS. 4A-4B, one embodiment of a replaceable marker 40 is shown both by itself and also secured within the interior 38 of housing 12. FIG. 4A actually shows a front view (left) and side view (right) of one embodiment of marker 40. As may be appreciated from FIG. 4B, when the marker 40 is in place within housing 12, the spring assembly 36 is compressed to exert a force sufficient to hold the marker 40 steadily in a fixed position during use.

Although not necessary, it is contemplated that the front face of the marker 40 has a transverse dimension that is approximately equal to the thickness of the housing. Of course, in order to work effectively, the cross-sectional dimensions of the marker is preferably such that it fits securely within support 34 for releaseable engagement with spring assembly 36. The side face preferably although not necessarily has a transverse dimension that is approximately equal the interior space of housing opening 32.

In one embodiment, marker 40 comprises a container 42 for containing a marking medium that be visibly discharged onto surface A. That marking medium may be one of a number of possible materials and properties. The marker 40 further comprises a support 44 for the marking means which, in one embodiment, comprises a plurality of brushes 46. When properly secured within housing 12, the brushes 46 of marker 40 extend through housing opening 32 so as to be exposed to surface A, as shown in FIGS. 1 and 2A-2B.

Referring to FIGS. 5A-5B, an alternative configuration of marker 140 and housing opening 132 are shown. Although they differences between the embodiments of FIGS. 4A-4B and 5A-5B are nuanced, they are sufficient to exemplify the possible variations in configurations. For example, in the embodiment of FIG. 4B, the housing is configured so as to have raised interior faces where the opening 32 and support 34 are positioned. In the embodiment of FIG. 5B, no such raised face is provided.

Embodiments of the present invention may be made from a number of different materials that provide durability and sturdiness. Various metals would be acceptable, as well as hard plastics, such as polycarbonates, would also be acceptable, or combinations of both for the combination of components. Other natural and synthetic materials may be used for some or all of the components as well.

Each of the embodiments described herein are illustrations of examples of the present invention and are not intended to restrict the scope of protection afforded the invention. A person of ordinary skill in the art should appreciate that variations in the configuration and materials are contemplated by the present invention without limitation to the specific embodiments presented. For example, the container may be cylindrical or non-cylindrical in shape. In other embodiments, there may be projections that are positioned at different axial positions around the periphery of the bottom member, with projections also provided in different axial positions corresponding to the location of the detents. In that regard, the scope of protection should be assessed based upon the appropriate construction of the claims as set forth below.

What is claimed is:

1. A marking device suitable for automatically marking locations at equidistant points along a surface, the device comprising:
a replaceable marker configured to durably apply a mark upon the surface from a fixed position, the marker comprising a applicator for applying the mark; and
a rotatable housing having an enclosed interior space, the rotatable housing having a removable face for securably and alternatively enclosing and exposing the interior space as desired, the rotatable housing further comprising an opening through which the marker applicator may extend to contact the surface, wherein the housing comprises a marker support configured to permit secure but releasable retention of the marker within the interior space of the housing,
wherein the device may be moved along the surface so that marks are applied to the surface at equidistant points.

2. The marking device of claim 1, further comprising a guide plate affixed to the housing to assist in guiding the motion of the device along the surface.

3. The marking device of claim 1, wherein the marker support comprises a spring mount to retain the marker in a fixed position while applying sufficient pressure to the marker applicator to reliably apply marks to the surface.

4. The marking device of claim 1, further comprising a handle securable to the housing.
